(19) United States
(12) Patent Application Publication
(10) Pub. No.: US 2010/0054604 A1
(43) Pub. Date: Mar. 4, 2010

(54) IMAGE PROCESSING APPARATUS AND PROGRAM RECORDING MEDIUM

(76) Inventor: Emi KUROKAWA, Yokohama-shi (JP)

Correspondence Address: OSTROLENK FABER GERB & SOFFEN, 1180 AVENUE OF THE AMERICAS, NEW YORK, NY, 100368403, US

(21) Appl. No.: 12/613,786

(22) Filed: Nov. 6, 2009

Related U.S. Application Data
(63) Continuation of application No. PCT/JP2008/058382, filed on May 1, 2008.

(30) Foreign Application Priority Data
May 11, 2007 (JP) 2007-127275

(51) Int. Cl. G06K 9/46

(52) U.S. Cl. 382/190

(57) ABSTRACT

An image processing apparatus configured to perform face detection on an image signal of an image to be processed, includes a target region setting unit configured to set a target region of a face detection process in the image to be processed, and a characteristic extraction unit configured to extract a characteristic of the image signal of the target region set by the target region setting unit. The image processing apparatus further includes a tone conversion unit configured to perform tone conversion on the image signal of the target region set by the target region setting unit according to the characteristic extracted by the characteristic extraction unit, and a face detection unit configured to detect a face region based on the image signal tone-converted by the tone conversion unit.

### CROSS-REFERENCE TO RELATED APPLICATIONS

This is a Continuation Application of PCT Application No. PCT/JP2008/058382, filed May 1, 2008, which was published under PCT Article 21(2) in Japanese.

This application is based upon and claims the benefit of priority from prior Japanese Patent Application No. 2007-127275, filed May 11, 2007, the entire contents of which are incorporated herein by reference.

### BACKGROUND OF THE INVENTION

1. Field of the Invention

The present invention relates to an image processing apparatus for performing face detection on an image signal of an image to be processed and a program recording medium for recording a program that causes a computer to execute the procedure of the image processing apparatus.

2. Description of the Related Art

Japanese Patent KOKAI Publication No. 2006-217277 discloses a technique of performing face detection of a person in a digital image captured by a digital camera, and performs exposure compensation and tone correction with a priority given to the detected region.

Japanese Patent KOKAI Publication No. 2006-309714 discloses a technique of performing face detection after performing a normalization process of performing brightness tone conversion on localized regions of an image to be distinguished, which will be subjected to face detection, so as to suppress variation in contrast.

The specification of U.S. Patent Application Publication No. 2006/0077264 discloses a technique as will be described below. That is, a plurality of image signals with different brightness levels are generated by applying different digital gains to an image signal in a region that will be subjected to face detection to generate, and face detection is performed on the image signals with different brightness levels. This reduces deterioration in precision of face detection due to situations under which an image is captured, such as backlight.

### BRIEF SUMMARY OF THE INVENTION

According to a first aspect of the present invention, there is provided an image processing apparatus configured to perform face detection on an image signal of an image to be processed, comprising:

a target region setting unit configured to set a target region of a face detection process in the image to be processed;

a characteristic extraction unit configured to extract a characteristic of the image signal of the target region set by the target region setting unit;

a tone conversion unit configured to perform tone conversion on the image signal of the target region set by the target region setting unit according to the characteristic extracted by the characteristic extraction unit; and

a face detection unit configured to detect a face region based on the image signal tone-converted by the tone conversion unit.

According to a second aspect of the present invention, there is provided a program recording medium having recorded therein a program for causing a computer to execute:

setting a target region of a face detection process in an image to be processed;

extracting a characteristic of the image signal of the set target region;

performing tone conversion on the image signal of the set target region according to the extracted characteristic; and

detecting a face region based on the tone-converted image signal.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 illustrates a configuration of a processing system of an image acquisition apparatus to which the image processing apparatus according to a first embodiment of the present invention is applied.

FIG. 2 illustrates a detailed configuration of a search area face detection circuit in FIG. 1.

FIG. 3 illustrates movement of a search area on an image to be processed.

FIG. 4 is a flowchart illustrating the entire procedure.

FIG. 5 is a flowchart illustrating the procedure of tone conversion and face detection processes in FIG. 4.

FIG. 6A illustrates tone conversion curves of tone conversion curve group A.

FIG. 6B illustrates tone conversion curves of tone conversion curve group B.

FIG. 6C illustrates tone conversion curves of tone conversion curve group C.

FIG. 6D illustrates tone conversion curves of tone conversion curve group D.

FIG. 6E illustrates tone conversion curves of tone conversion curve group E.

FIG. 7 is a flowchart illustrating details of a selection process of the tone conversion curve groups in FIG. 5.

FIG. 8 illustrates the relationship between maximum and minimum brightnesses of pixels and a selection region of a tone conversion curve group.

FIG. 9 illustrates a configuration of a processing system of an image acquisition apparatus to which the image processing apparatus according to a second embodiment of the present invention is applied;

FIG. 10 illustrates an example of a region to be processed in an image to be processed.

FIG. 11 illustrates other example of a region to be processed in an image to be processed.

FIG. 12 illustrates a detailed configuration of the tone conversion circuit of FIG. 9.

### DETAILED DESCRIPTION OF THE INVENTION

Hereinafter, the best mode for carrying out the present invention will be described with reference to the drawings.

### First Embodiment

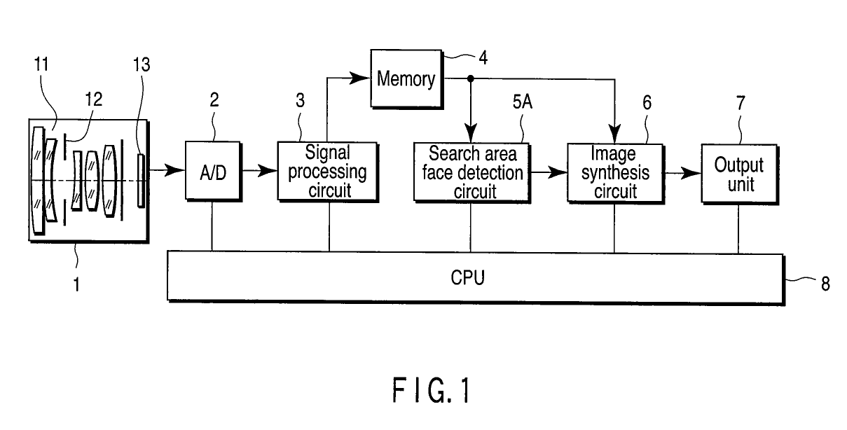

As shown in FIG. 1, an image acquisition apparatus to which an image processing apparatus according to a first embodiment of the present invention is applied includes an image acquisition unit 1, an analog-to-digital converter (A/D) 2, a signal processing circuit 3, a memory 4, a search area face detection circuit 5A, an image synthesis circuit 6, an output unit 7, and a CPU 8.

The image acquisition unit 1 includes a lens system 11, an aperture 12, and a CCD 13. An image captured by the CCD 13 of the image acquisition unit 1 is converted into a digital signal by the analog-to-digital converter 2. The image signal converted into the digital signal from the analog-to-digital converter 2 is input to the signal processing circuit 3 to be subjected to a noise reduction process, and then stored in the memory 4 as an image signal of an image to be processed. The image signal stored in the memory 4 is input to the search area face detection circuit 5A. The search area face detection circuit 5A extracts characteristics from the image signal input from the memory 4, and performs tone conversion on the image signal input from the memory 4 according to the extracted characteristics. The search area face detection circuit 5A then performs face detection on the tone-converted image signal. The result of the face detection is input to the image synthesis circuit 6. An image signal is input to the image synthesis circuit 6 from the memory 4, too. The image synthesis circuit 6 combines the result of the face detection input from the search area face detection circuit 5A with the image signal input from the memory 4. For example, the image signal input from the memory 4 is combined with an image of a frame in a position where a face is detected. The image signal combined with the result of the face detection is input to the output unit 7. The output unit 7 includes a memory card, a display element, and so forth. The CPU 8 controls the analog-to-digital converter 2, the signal processing circuit 3, the search area face detection circuit 5A, the image synthesis circuit 6, and the output unit 7.

Needless to say, the CPU 8 is capable of adjusting the focus of the lens system 11 of the image acquisition unit 11 such that proper focus is obtained in the position where a face is detected.

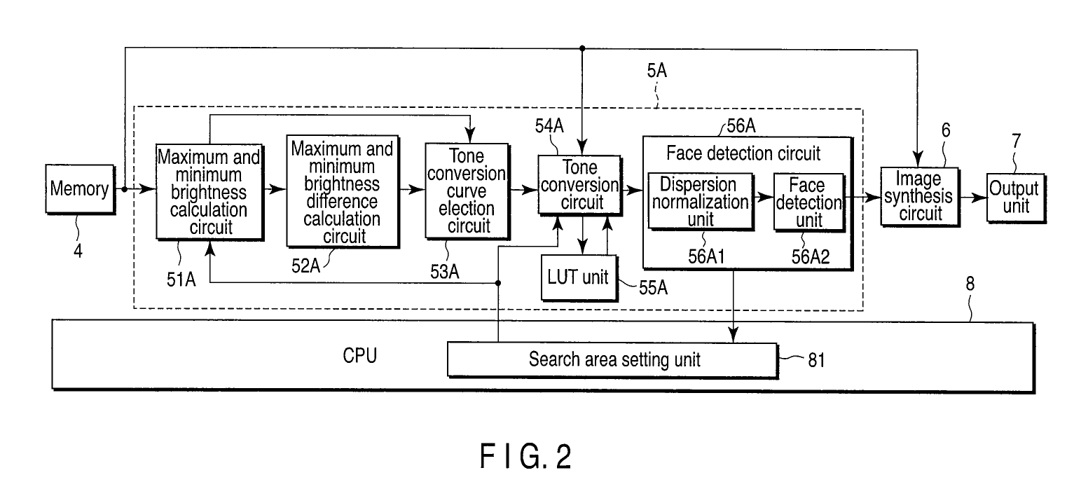

The search area face detection circuit 5A includes a maximum and minimum brightness calculation circuit 51A, a maximum and minimum brightness difference calculation circuit 52A, a tone conversion curve selection circuit 53A, a tone conversion circuit 54A, an LUT unit 55A and a face detection circuit 56A, as shown in FIG. 2.

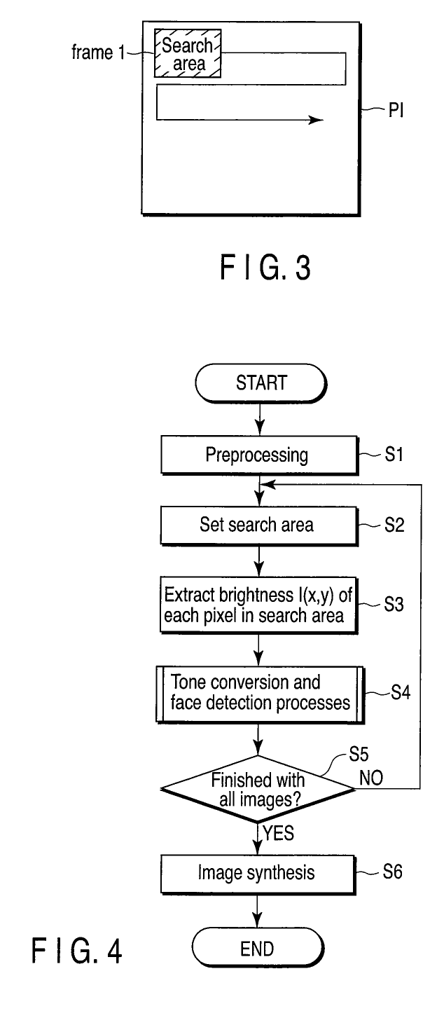

The maximum and minimum brightness calculation circuit 51A reads an image signal of a search area in an image to be processed from the memory 4, and calculates maximum and minimum brightnesses of the search area. It is to be noted that the search area is set by a search area setting unit 81, which is a function of the CPU 8. As shown in FIG. 3, a search area frame1 has a predetermined size with respect to an image to be processed PI. The search area setting unit 81 sets the search area frame1 such that the search area frame1 moves from the upper left to the lower right of the image to be processed PI. The degree of movement may be per pixel, or per predetermined number of overlapping pixels.

The maximum and minimum brightnesses calculated by the maximum and minimum brightness calculation circuit 51A are input to the maximum and minimum brightness difference calculation circuit 52A, and to the tone conversion curve selection circuit 53A. The maximum and minimum brightness difference calculation circuit 52A calculates the difference between the maximum and minimum input brightnesses, and inputs the calculated difference to the tone conversion curve selection circuit 53A. The tone conversion curve selection circuit 53A selects a tone conversion curve to be used for tone conversion from preset tone conversion curves. The selection is performed based on the maximum and minimum brightnesses input from the maximum and minimum brightness calculation circuit 51A, and the difference between the maximum and minimum brightnesses input from the maximum and minimum brightness difference calculation circuit 52A. The result of the selection is input to the tone conversion circuit 54A.

The tone conversion circuit 54A converts the tone of each pixel of an image signal of the search area frame1 in the image to be processed PI retrieved from the memory 4 into a tone according to the result of the selection of the tone conversion curve, as will be described below. That is, a plurality of tone conversion curves are stored in advance in the LUT unit 55A in the form of LUTs. The tone conversion circuit 54A provides an LUT of the LUT unit 55A corresponding to the selected tone conversion curve with the tone of each pixel of the image signal of the search area frame1 in the image to be processed PI read from the memory 4. A converted tone corresponding to the tone is output from the LUT of the LUT unit 55A, and the tone conversion circuit 54A acquires the converted tone. The tone-converted image signal of the search area frame1 is input to the face detection circuit 56A. The face detection circuit 56A normalizes the dispersion of brightnesses of the input tone-converted image signal, and performs face detection based on the normalized image signal.

Next, the entire procedure will be described with reference to FIG. 4.

This procedure is started by pressing the first stage of a two-stage shutter button, not shown, for example.

First, the signal processing circuit 3 performs a noise reduction process on an image signal of the image to be processed PI captured in the image acquisition unit 1 as preprocessing (step S1). After that, the search area setting unit 81 sets a search area frame1 in the noise-reduced image signal (step S2).

Then, the search area face detection circuit 5A extracts the brightness I(x,y) of each pixel of the search area frame1 (step S3). A tone conversion process is performed according to the brightness I(x,y), and then a face detection process is performed (step S4). After that, it is determined whether the tone conversion process and the face detection process have been performed on the entire image to be processed PI (step S5). If the processes have not been finished for the entire image, the procedure returns to step S2, at which the search area frame1 is set and the above-described processes are repeated.

If the tone conversion and face detection processes have been finished for the entire image to be processed PI (step S5), the image synthesis circuit 6 combines the result of face detection into the image to be processed PI (step S6). The image to be processed PI into which the result of the face detection has been combined is output to the output unit 7, such as a memory card or a display device.

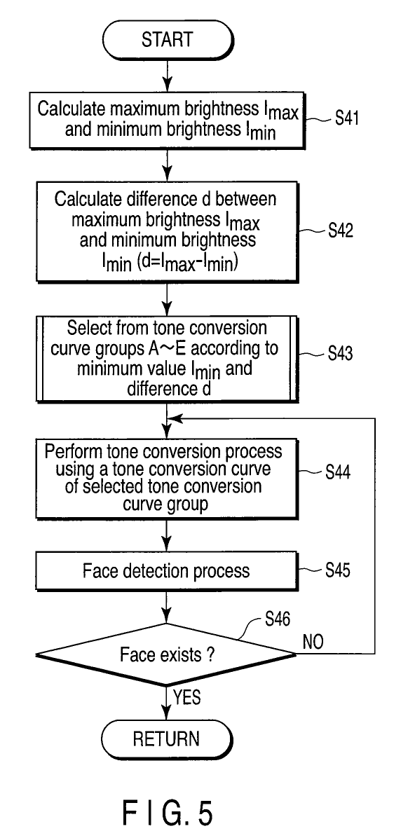

Next, the procedure of the tone conversion and face detection processes performed in step S4 will be described with reference to FIG. 5.

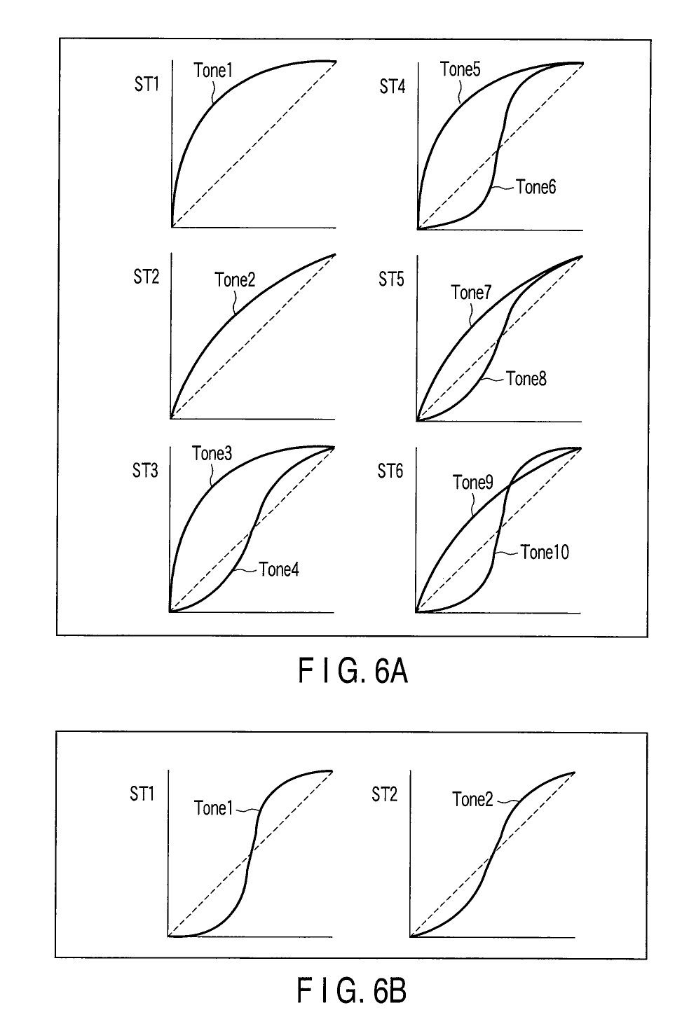

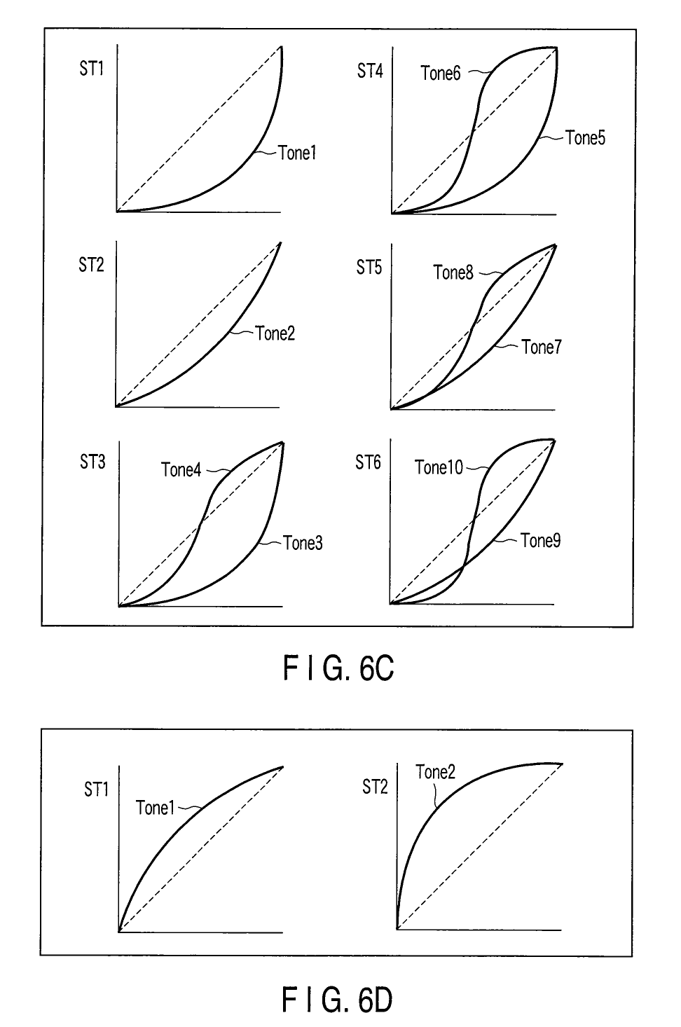

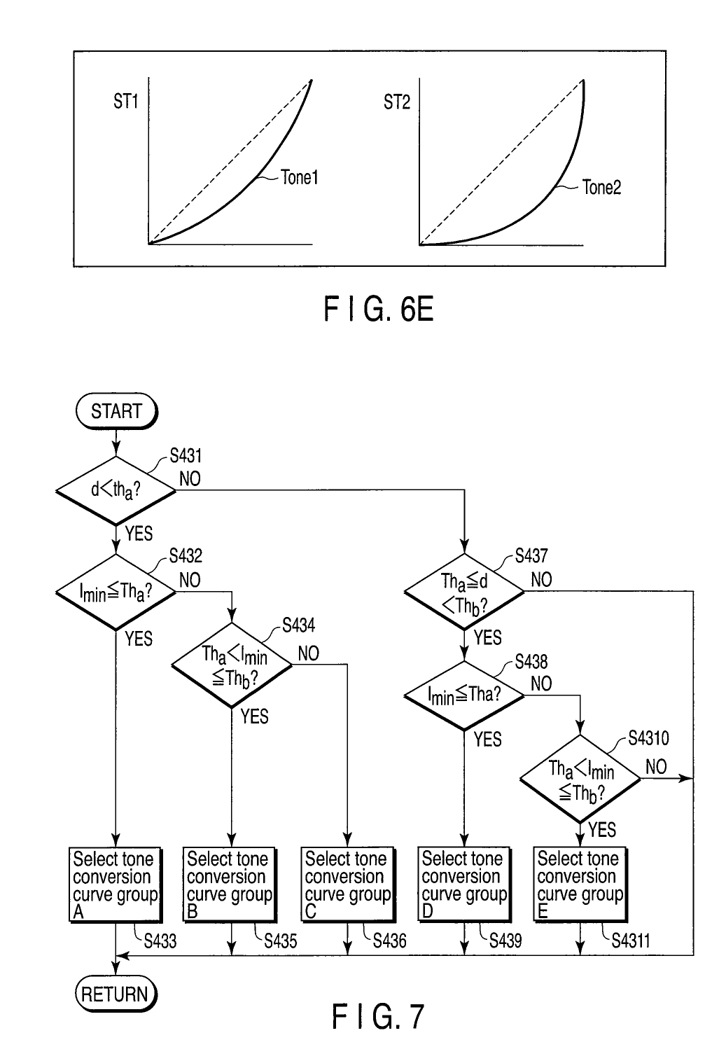

First, a maximum brightness Iₘₐₓ and a minimum brightness Iₘᵢₙ of the search area frame1 are calculated by the maximum and minimum brightness calculation circuit 51A from the brightness I(x,y) of each pixel of the search area frame1 extracted in step S3 (step S41). Next, the maximum and minimum brightness difference calculation circuit 52A calculates a difference d between the maximum brightness Iₘₐₓ and the minimum brightness Iₘᵢₙ of the search area frame1 (step S42). After that, according to the calculated minimum brightness Iₘᵢₙ and the difference d between the maximum brightness Iₘₐₓ and the minimum brightness Iₘᵢₙ, a tone conversion curve group is selected from tone conversion curve groups A to E shown in FIGS. 6A to 6E (step S43).

After that, the tone conversion circuit 54A performs tone conversion on the search area frame1 using one of the tone conversion curves of the selected tone conversion curve group (step S44). After that, the face detection circuit 56A performs a face detection process on the search area frame1 (step S46), and determines whether a face exists (step S46).

If it is determined that a face does not exist, the procedure returns to step S44, and tone conversion of the search area frame1 is performed using another tone conversion curve of the selected tone conversion curve group.

If it is determined in step S46 that a face exists, the tone conversion and face detection processes are finished, and the procedure returns to the upper routine.

Next, details of the selection process of the tone conversion curve group of step S43 performed by the tone conversion curve selection circuit 53A will be described with reference to FIG. 7. In the descriptions that follow, Thₐ and Th_{b} are assumed to be brightness thresholds, and the brightnesses are assumed to be 256 tones from 0 to 255.

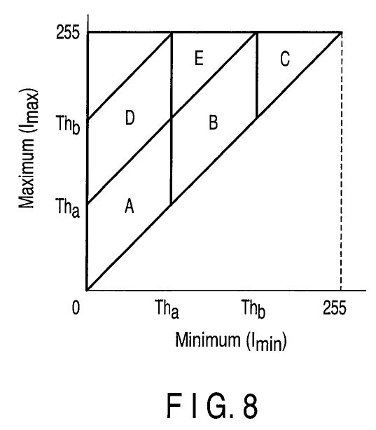

First, it is determined whether the difference d between the maximum brightness Iₘₐₓ and the minimum brightness Iₘᵢₙ of the search area frame1 is less than threshold Thₐ; d<Thₐ (step S431). If it is determined that the relationship d<Thₐ is satisfied, it is further determined whether the minimum brightness Iₘᵢₙ of the search area frame1 is less than or equal to threshold Thₐ; I≦Thₐ (step S432). If it is determined that the relationship Iₘᵢₙ≦Thₐ is satisfied, that is, the relationships d<Thₐ and Iₘᵢₙ≦Thₐ are satisfied, the search area frame1 is assumed to fall under area A shown in FIG. 8, and tone conversion curve group A shown in FIG. 6A is selected (step S433), and the procedure returns to the upper routine.

On the other hand, if it is determined in step S432 that the relationship Iₘᵢₙ≦Thₐ is not satisfied, it is further determined whether the minimum brightness Iₘᵢₙ of the search area frame1 is greater than threshold Thₐ and less than or equal to threshold Th_{b}; Thₐ<Iₘᵢₙ≦Th_{b} (step S434). If it is determined that the relationship Thₐ<Iₘᵢₙ≦Th_{b} is satisfied, that is, when the relationships d<Thₐ and Thₐ<I≦Th_{b} are satisfied, the search area frame1 is assumed to fall under area B in FIG. 8, tone conversion curve group B as shown in FIG. 6B is selected (step S435), and the procedure returns to the upper routine. Further, if it is determined that the relationship Thₐ<Iₘᵢₙ≦Th_{b} is not satisfied, that is, when the relationships d<Thₐ and Th_{b}<Iₘᵢₙ≦255 are satisfied, the difference d is assumed to fall under area C in FIG. 8, tone conversion curve group C shown in FIG. 6C is selected (step S436), and the procedure returns to the upper routine.

On the other hand, if it is determined in step S431 that the relationship is not d<Thₐ is not satisfied, it is determined whether the difference d between the maximum brightness Iₘₐₓ and the minimum brightness Iₘᵢₙ of the search area frame1 is greater than or equal to threshold Thₐ and less than threshold Th_{b}; Thₐ≦d≦Th_{b} (step S437). If it is determined that the relationship Thₐ≦d<Th_{b} is satisfied, it is further determined whether the minimum brightness Iₘᵢₙ of the search area frame1 is less than or equal to threshold Thₐ; Iₘᵢₙ≦Thₐ (step S438). If it is determined that the relationship Iₘᵢₙ≦Thₐ is satisfied, i.e., the relationships Thₐ≦d<Th_{b} and Iₘᵢₙ≦Thₐ are satisfied, the search area frame1 is assumed to fall under area D in FIG. 8, tone conversion curve group D shown in FIG. 6D (step S439) is selected, and the procedure returns to the upper routine.

On the other hand, if it is determined in step S438 that the relationship Iₘᵢₙ≦Thₐ is not satisfied, it is further determined whether the minimum brightness Iₘᵢₙ of the search area frame1 is greater than threshold Thₐ and less than or equal to threshold Th_{b}; Thₐ≦Iₘᵢₙ≦Th_{b} (step S4310). If it is determined that the relationship Thₐ<Iₘᵢₙ≦Th_{b} is satisfied, that is, when the relationships Thₐ≦d<Th_{b} and Thₐ<Iₘᵢₙ≦Th_{b} are satisfied, the search area frame1 is assumed to fall under area E in FIG. 8, tone conversion curve group E shown in FIG. 6E is selected (step S4311), and the procedure returns to the upper routine.

If it is determined that the relationship Thₐ<Iₘᵢₙ≦Th_{b} is not satisfied, that is, if none of the conditions of the tone conversion curve selection is applied, none of the tone conversion curve groups is selected and the procedure returns to the upper routine.

Thus, the tone conversion process using a tone conversion curve of the selected tone conversion curve group is performed in step S44. When none of the tone conversion curve groups is selected in step S43, the tone conversion process of step S44 is not performed and the face detection of step S45 will be performed.

Next, the procedure of the tone conversion process using the tone conversion curve of the selected tone conversion curve group will be described with reference to FIGS. 6A to 6E. It is to be noted that the horizontal axis of the conversion curves represents an input brightness, and the vertical axis represents a conversion output brightness.

No matter which of tone conversion curve groups A to E is selected, tone conversion is sequentially performed using tone conversion curves step by step (step ST1, step ST2, etc.), and when tone conversion is finished in one step, a face detection process is performed.

In tone conversion curve group A and tone conversion curve group C, tone conversion curves are set for steps ST1 to ST6, and in tone conversion curve group B, tone conversion curve group D, and tone conversion curve group E, tone conversion curves are set for steps ST1 and ST2.

Further, in step ST3, in tone conversion curve group A and tone conversion curve group C, tone conversion is performed using tone conversion curve Tone3 and then tone conversion is performed using tone conversion curve Tone4, and then the procedure proceeds to a face detection process. In steps ST4 to ST6, as in the case of step ST3, tone conversion is performed sequentially using two kinds of tone conversion curves. That is, step ST4 uses tone conversion curve Tone5 and tone conversion curve Tone 6 in this order. Step ST5 uses tone conversion curve Tone7 and tone conversion curve Tone8 in this order. Step ST6 uses tone conversion curve Tone 9 and tone conversion curve Tone10 in this order.

Hereinafter, characteristics of tone conversion curve groups A to E will be described with reference to FIG. 8, along with FIGS. 6A to 6E.

Area A shown in FIG. 8 is in an area where the maximum brightness Iₘₐₓ and the minimum brightness Iₘᵢₙ are dark, and the difference d between the maximum brightness Iₘₐₓ and the minimum brightness Iₘᵢₙ is relatively small. Accordingly, the search area frame1 is considered to be dark as a whole, and low-contrast. Therefore, tone conversion curve group A (FIG. 6A) is configured to perform tone conversion so as to increase the overall brightness of the search area frame1 first (steps ST1 and ST2 in FIG. 6A). When a face is still not detected, tone conversion is performed so as to increase the overall brightness of the search area frame1 and enhance the contrast (steps ST3 to ST6 in FIG. 6A.)

In area B shown in FIG. 8, the maximum brightness Iₘₐₓ and the minimum brightness Iₘᵢₙ are in an intermediate area and the difference d between the maximum brightness Iₘₐₓ and the minimum brightness Iₘᵢₙ is relatively small. Accordingly, the search area frame1 is considered to be suitable for face detection in terms of the overall brightness, but low-contrast. Therefore, tone conversion curve group B (FIG. 6B) is configured to perform tone conversion so as to enhance the contrast of the search area frame1 (steps ST1 and ST2 in FIG. 6B).

In area C shown in FIG. 8, the maximum brightness Iₘₐₓ and the minimum brightness Iₘᵢₙ are in a bright area, and the difference between the maximum brightness Iₘₐₓ and the minimum brightness Iₘᵢₙ is relatively small. Accordingly, the search area frame1 is considered to be bright as a whole, and is considered to be low-contrast. Therefore, tone conversion curve group C (FIG. 6C) is configured to perform tone conversion so as to reduce the overall brightness of the search area frame1 (steps ST1 and ST2 in FIG. 6C). If a face is still not detected, tone conversion is performed so as to reduce the overall brightness of the search area frame1 and enhance the contrast (steps ST3 to ST6 in FIG. 6A).

In area D shown in FIG. 8, the maximum brightness Iₘₐₓ is in an intermediate area and the minimum brightness Iₘᵢₙ is in a dark area. Accordingly, the search area frame1 is considered to be in a relatively dark area as a whole. Therefore, tone conversion curve group D (FIG. 6D) performs tone conversion so as to increase the overall brightness of the search area frame1 (steps ST1 and ST2 in FIG. 6D). In tone conversion curve group A, the brightness of the search area frame1 is greatly increased in step ST1 using a large tone conversion curve. In area D, compared to area A, the maximum brightness Iₘₐₓ is in a bright area. Therefore, tone conversion curve group D is configured to perform tone conversion so as to gradually increase brightness of the search area frame1, using a relatively small tone conversion curve in step ST1.

In area E shown in FIG. 8, the maximum brightness Iₘₐₓ is in a bright area and the minimum brightness Iₘᵢₙ is in an intermediate area. Accordingly, the search area frame1 is considered to be in a relatively bright area as a whole. Therefore, tone conversion curve group E (FIG. 6E) is configured to perform tone conversion so as to reduce the overall brightness of the search area frame1 (steps ST1 and ST2 in FIG. 6E). In tone conversion curve group C, the brightness of the search area frame1 is greatly reduced using a large tone conversion curve first in step ST1. Compared to area C, the minimum brightness Iₘᵢₙ of area E is in a dark area. Therefore, tone conversion curve group E is configured to perform tone conversion so as to gradually reduce the brightness of the search area frame1, using a relatively small tone conversion curve in step ST1.

In the face detection process of step S45, face detection is performed by the face detection circuit 56A on a signal tone-converted by the tone conversion circuit 54A. In the present embodiment, the face detection circuit 56A includes a dispersion normalization unit 56A1 and a face detection unit 56A2, as shown in FIG. 2. The dispersion normalization unit 56A1 performs a dispersion normalization process of brightnesses over a tone-converted signal. The face detection unit 56A2 performs face detection on the signal subjected to the dispersion normalization process of the brightnesses. The dispersion normalization process refers to smoothing frequent distribution (histogram) of the brightnesses and normalizing the contrast, for example. It is thereby possible to minimize the influence of change in illumination conditions on change in brightness. The face detection is performed using the face detection scheme by Viola-Jones, for example. Details of the face detection scheme by Viola-Jones are disclosed in P. Viola and M. Jones, “Rapid object detection using a boosted cascade of simple features,” Proc. of CVPR, 2001. The face detection scheme by Viola-Jones is to detect a face by matching a rectangular filter optimum for face detection selected by learning of AdaBoost with an image to be subjected to face detection. A cascade arrangement of the rectangular filters enables enhanced processing.

As described above, according to the first embodiment of the present invention, before face detection is performed, the relationship between the maximum brightness Iₘₐₓ and the minimum brightness Iₘᵢₙ is determined as a characteristic of the search area frame1, and tone conversion is performed so as to: enhance bright contrast when the search area frame1 is dark; enhance dark contrast when the search area frame1 is whited out; and enhance contrast of the search area frame1 when none of the above-described conditions is met. Since tone conversion is thus performed according to the situations, face detection can be performed even when the face region is dark, whited out, or low-contrast. That is, tone conversion that is optimum for face detection is performed by performing tone conversion according to the conditions, and the rate of face detection can be increased.

Needless to say, the face detection rate can be further increased by performing several patterns of the procedure of tone conversion and face detection of the search area frame1 by modifying the size of the search area frame1.

Further, in the first embodiment of the present invention, since face detection is performed for a divided search area frame1, the rate of the face detection can be enhanced. In this case, face detection can be performed on the entire image to be processed PI by moving the search area frame1. Furthermore, since the procedure can proceed to the next search area frame1 after a face is detected, face detection can be performed on the entire image to be processed PI at fast speed.

Further, since brightnesses are used as a characteristic of the search area frame1, characteristic detection can be performed easily, and face detection can be performed even when the face region is dark or whited out.

### Second Embodiment

Next, a second embodiment of the present invention will be described. The structures similar to those of the first embodiment will be denoted by the same reference numerals, and detailed descriptions of such structures will be omitted.

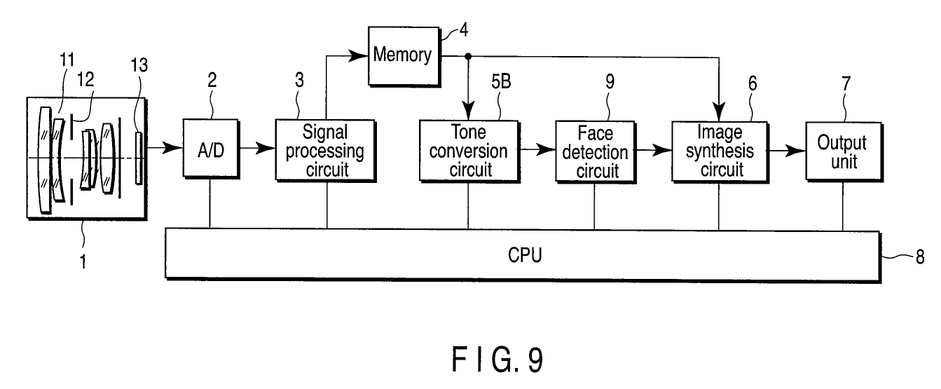

In an image acquisition apparatus to which the image processing apparatus according to the second embodiment of the present invention is applied, an image signal stored in a memory 4 is input to a tone conversion circuit 5B, and tone conversion is performed on each region to be processed, as shown in FIG. 9. A face detection circuit 9 performs face detection on an image signal of the tone-converted region to be processed.

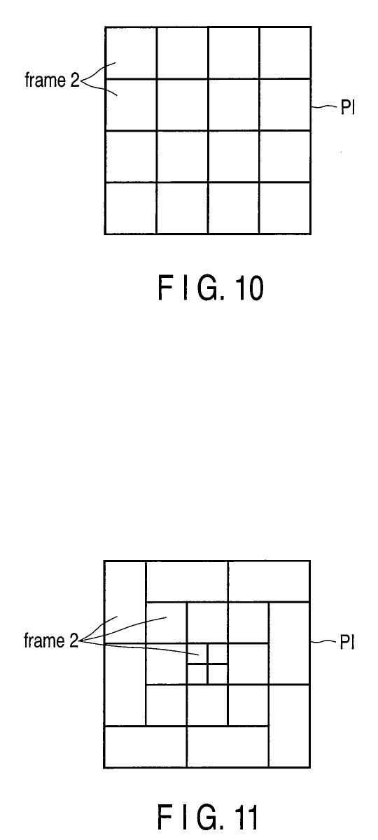

The region to be processed refers to each divided region when the entire image to be processed PI is divided into more than two, such as 16 or 32. For example, FIG. 10 illustrates regions to be processed frame2 when the image to be processed PI is divided into 16. Tone conversion and face detection are performed on all the target regions of each region to be processed frame2. That is, in the first embodiment, the target region is a search area frame1, which moves on an image to be processed PI. On the other hand, the present embodiment sets a fixed position obtained by dividing the image to be processed PI in a predetermined size as the regions to be processed frame2. Of course, the division is not limited to equally dividing the entire image to be processed PI as shown in FIG. 10. The division may be unequally performed according to the position on an image, such as dividing the central unit of an image, in which a face is likely to exist, in a smaller size.

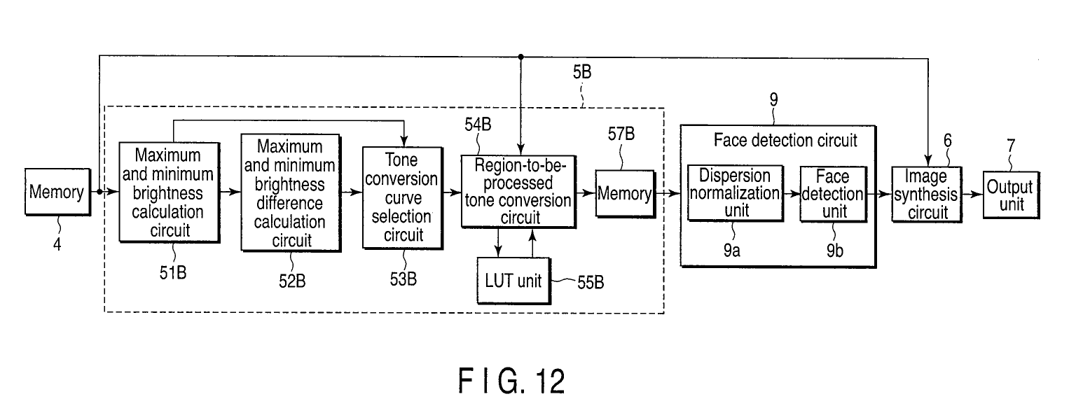

The tone conversion circuit 5B includes a maximum and minimum brightness calculation circuit 51B, a maximum and minimum brightness difference calculation circuit 52B, a tone conversion curve selection circuit 53B, a region-to-be-processed tone conversion circuit 54B, an LUT unit 55B, and a memory 57B, as shown in FIG. 12.

The maximum and minimum brightness calculation circuit 51B reads an image signal of a region to be processed frame2 preset in the image to be processed PI from the memory 4, and calculates maximum and minimum brightnesses of the region to be processed frame2.

The maximum and minimum brightnesses of the region to be processed frame2 calculated by the maximum and minimum brightness calculation circuit 51B are input to the maximum and minimum brightness difference calculation circuit 52B, and are also input to the tone conversion curve selection circuit 53B. The maximum and minimum brightness difference calculation circuit 52B calculates a difference between the maximum and minimum brightnesses of the input region to be processed frame2, and input the calculated difference to the tone conversion curve selection circuit 53B. The tone conversion curve selection circuit 53B selects a tone conversion curve for the region to be processed frame2 from preset tone conversion curves. The selection is performed based on the maximum and minimum brightnesses of the region to be processed frame2 input from the maximum and minimum brightness calculation circuit 51B and the difference between the maximum and minimum brightnesses of the region to be processed frame2 input from the maximum and minimum brightness difference calculation circuit 52B. The result of the selection is input to the tone conversion circuit 54B.

In the present embodiment, as in the case of the first embodiment, a plurality of tone conversion curves are stored in advance in the form of LUTs in the LUT unit 55B. The tone conversion circuit 54B supplies an LUT of the LUT unit 55B corresponding to the selected tone conversion curve for the region to be processed frame2 with the tone of each pixel of the image signal of the region to be processed frame2 in the image to be processed PI read from the memory 4.

The tone conversion circuit 54B then acquires a converted tone corresponding to the tone of each pixel from the corresponding LUT of the LUT unit 55B. The tone-converted image signal of the region to be processed frame2 is stored in an area corresponding to the region to be processed frame2 of the memory 57B.

After that, the above-described procedure is performed on the next region to be processed frame2 set in advance, tone conversion is performed on the region to be processed frame2, and the result is stored in the memory 57B. Similarly, tone conversion is performed on all the regions to be processed frame2 set in advance of the image to be processed PI, and the result thereof is stored in an area corresponding to the region to be processed frame2 of the memory 57B.

When tone conversion of all the regions to be processed frame2 has finished, the face detection circuit 9 further normalizes dispersion of the brightnesses of the tone-converted image signal stored in the memory 57B, and performs face detection on the normalized image signal. That is, the face detection circuit 9 includes a dispersion normalization unit 9a and a face detection unit 9b. The dispersion normalization unit 9a and the face detection unit 9b perform the same procedures as those of the distribution normalization unit 56A1 and the face detection unit 56A2 of the first embodiment.

Other than those stated above, the second embodiment is the same as the first embodiment.

As stated above, according to the second embodiment of the present invention, the relationship between the maximum brightness Iₘₐₓ and the minimum brightness Iₘᵢₙ is determined as a characteristic of the region to be processed frame2 before face detection is performed, and tone conversion is performed so as to: enhance bright contrast when the region to be processed frame2 is dark; enhance dark contrast of the region to be processed frame2 when the region to be processed frame2 is whited out; and enhance contrast of the region to be processed frame2 when none of the above-described conditions are met.

Since tone conversion is thus performed according to the situations, face detection can be performed even when the face region is dark, bleached looking, or low-contrast. That is, tone conversion optimum for face detection is performed by performing tone conversion according to the conditions, and the rate of face detection can be increased.

Further, since tone conversion is performed not on the entire image to be processed PI, but per smaller unit of the region to be processed frame2, even when characteristics are locally different, tone conversion can be performed according to the characteristics and the rate of face detection can be increased.

The entire image to be processed PI may be divided into a plurality of divided patterns, such as 16, 32, or 64, and a region to be processed frame2 may be set in advance in each divided pattern. In this case, tone conversion is performed on each divided region in each pattern and the result is stored in the memory 57B, and the face detection circuit 9 performs a face detection process on all the divided patterns stored in the memory 57B. The face detection result obtained by each divided pattern is combined with the original image to be processed PI by the image synthesis circuit 6.

By thus performing several patterns of tone conversion and face detection processes on the region to be processed frame2 by modifying the size of the region to be processed frame2, the rate of face detection can be further increased.

It is to be noted that the size or position of each region to be processed frame2 in one or more of the divided patterns are predetermined and preset in the maximum and minimum brightness calculation circuit 51B and the tone conversion circuit 54B for performing tone conversion on a target region. Of course, the pattern selected by the CPU 8 may be switched according to the selection by the user such that the region to be processed frame2 can be set.

The procedures of the image processing apparatus of the above-described embodiments may be stored in a program recording medium and distributed as a program capable of being executed by a computer. Further, by reading and executing the program stored in the program recording medium, a computer can be operated as an image processing apparatus for performing the above-described procedures.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. An image processing apparatus configured to perform face detection on an image signal of an image to be processed, comprising:
a target region setting unit configured to set a target region of a face detection process in the image to be processed;
a characteristic extraction unit configured to extract a characteristic of the image signal of the target region set by the target region setting unit;
a tone conversion unit configured to perform tone conversion on the image signal of the target region set by the target region setting unit according to the characteristic extracted by the characteristic extraction unit; and
a face detection unit configured to detect a face region based on the image signal tone-converted by the tone conversion unit.

2. The image processing apparatus according to claim 1, wherein the face detection unit detects a face region in each target region tone-converted by the tone conversion unit.

3. The image processing apparatus according to claim 2, wherein the target region setting unit includes a target region movement unit configured to set the target region to move.

4. The image processing apparatus according to claim 1, wherein the target region setting unit sets each region obtained by dividing the image to be processed into more than two as the target region.

5. The image processing apparatus according to claim 4, wherein
the division of the image to be processed into more than two is division into target regions in different sizes, and
the target region setting unit sets each of the divided region in each size as the target region.

6. The image processing apparatus according to claim 1, wherein
the characteristic extraction unit includes a calculation unit configured to calculate maximum and minimum values from brightness values of pixels of the target region set by the target region setting unit, and
the tone conversion unit includes:
a tone conversion curve selection unit configured to select a tone conversion curve to be used for tone conversion from preset tone conversion curves according to a relationship between the maximum and the minimum of the brightness values of the pixels of the target region calculated by the calculation unit; and
a conversion unit configured to perform a tone conversion process using the tone conversion curve selected by the tone conversion curve selection unit.

7. The image processing apparatus according to claim 6, wherein the tone conversion curve selection unit selects a preset tone conversion curve according to a difference between the maximum and the minimum of the brightness values of the target region and one of the maximum value and the minimum value.

8. The image processing apparatus according to claim 1, wherein the tone conversion unit performs new tone conversion on the image signal of the target region when a face is not detected by the face detection unit, so as to cause the face detection unit to perform face detection again.

9. The image processing apparatus according to claim 2, wherein the tone conversion unit ends the tone conversion process on the image signal of the target region when a face is detected by the face detection unit.

10. The image processing apparatus according to claim 1, wherein the face detection unit includes a normalization unit configured to further normalize dispersion of the tone-converted image signal, and is configured to detect the face region using the normalized image signal.

11. A program recording medium having recorded therein a program for causing a computer to execute:
setting a target region of a face detection process in an image to be processed;
extracting a characteristic of the image signal of the set target region;
performing tone conversion on the image signal of the set target region according to the extracted characteristic; and
detecting a face region based on the tone-converted image signal.
